(19) United States
(12) Patent Application Publication
(10) Pub. No.: US 2021/0134177 A1
(43) Pub. Date: May 6, 2021

(54) SYSTEM AND METHOD FOR DISPLAYING VOICE-ANIMATED MULTIMEDIA CONTENT

(71) Applicant: Yap Technology, Ltd., Luton (GB)

(72) Inventor: Benjamin Ridgway, Luton (GB)

(21) Appl. No.: 17/082,278

(22) Filed: Oct. 28, 2020

Related U.S. Application Data
(60) Provisional application No. 62/927,725, filed on Oct. 30, 2019.

(51) Int. Cl. G09B 17/00; G06T 13/80; G06T 13/20; G10L 15/22; G10L 15/187; G06F 3/16; G09B 19/04

(52) U.S. Cl. CPC G09B 17/006; G06T 13/80; G06T 13/205; G10L 15/22; G06F 3/0482; G06F 3/167; G09B 19/04; G06T 2200/24; G10L 15/187

(57) ABSTRACT

A system and methods for displaying voice-animated multimedia content through a story. A computer-implemented method for animating multimedia content includes creating a customized story based on input from a user, the input determining one or more words and one or more types of multimedia content for the story; synchronizing the one or more types of multimedia content to match the one or more words of the story; displaying the words of the story to a user via a computing device; determining whether the words of the story were correctly vocalized in the correct order by the user; playing the multimedia content through a display and an audio output on the computing device in response to one or more correctly vocalized words in the story by the user; and analyzing the user's reading and pronunciation of the words in the story.

### CROSS REFERENCE TO RELATED APPLICATIONS

The present application claims the benefit to U.S. Provisional Patent Application No. 62/927,725 filed on Oct. 30, 2019, which is incorporated herein by reference in its entirety.

### FIELD

The present disclosure relates to a system and method for displaying voice-animated multimedia content through a story.

### BACKGROUND

Electronic books have grown in popularity due to their portability and capability to store numerous digital copies of books and other reading materials. Electronic books are commonly used by children for providing various features to the text of a book, such as graphics, audio, animation, and video. Several systems exist to provide electronic books that help children learn how to read. However, these existing systems often fail to sufficiently engage and entertain a child while developing and assessing the child's specific reading and speech patterns.

Consequently, there is a need for a method and a system that can help users learn to read and properly pronounce words through an immersive and engaging story-telling experience.

### SUMMARY

A system and methods for displaying voice-animated multimedia content through an immersive story. The story is designed to help children learn how to read and properly pronounce words.

In an embodiment, a computer-implemented method for animating multimedia content includes creating a customized story based on input from a user, the input determining one or more words and one or more types of multimedia content for the story; synchronizing the one or more types of multimedia content to match the one or more words of the story; displaying the words of the story to a user via a computing device; determining whether the words of the story were correctly vocalized in the correct order by the user; playing the multimedia content through a display and an audio output on the computing device in response to one or more correctly vocalized words in the story by the user; analyzing the user's reading and pronunciation of the words in the story; and displaying on the computing device the analysis of the user's reading and pronunciation of the words in the story.

In another embodiment, a computer-implemented method for animating multimedia content includes displaying a list of stories to a user via a computing device; synchronizing one or more types of multimedia content to match one or more words of a story selected by the user; displaying the words of the story on the computing device for the user to vocalize; determining whether the words of the story were correctly vocalized in the correct order by the user; playing the multimedia content through a display and an audio output on the computing device in response to one or more correctly vocalized words in the story by the user; analyzing the user's reading and pronunciation of the words in the story; and displaying on the computing device the analysis of the user's reading and pronunciation of the words in the story.

In an embodiment, a system for animating multimedia content includes a first computing device having a microphone; a display; an audio input; and an audio output. The system also includes a second computing device in communication with the first computing device, wherein the second computing device has one or more databases; one or more servers in communication with the one or more databases; one or more processors; a computer-readable memory encoding instructions that, when executed by the one or more processors, create a voice animation engine configured to generate one or more types of multimedia content. The voice animation engine includes a customization module programmed to create a story based on input received from the first computing device; a voice analysis module programmed to analyze words in the story spoken by a user via the first computing device, wherein the voice analysis module includes a voice analysis controller; a multimedia coordination module programmed to synchronize the output from the voice analysis module with one or more types of multimedia content; and a performance analysis module programmed to analyze and report the user's reading and pronunciation of the words in the story.

In some embodiments, the types of multimedia content includes images, videos, text, slide transitions, audio, downloadable content, GIF animation, color backgrounds, page turns, and/or any combinations thereof.

### BRIEF DESCRIPTION OF THE DRAWINGS

The above, as well as other advantages of the present disclosure, will become readily apparent to those skilled in the art from the following detailed description when considered in light of the accompanying drawings in which:

FIG. 1 illustrates an example system for generating multimedia content according to an embodiment of the disclosure;

FIG. 2 illustrates a block diagram of example modules of a voice animation engine illustrated in FIG. 1;

FIGS. 3A and 3B illustrate example displays of a home page generated by the system illustrated in FIGS. 1 and 2;

FIG. 4 illustrates an example display of a story page generated by the system illustrated in FIGS. 1 and 2;

FIG. 5 illustrates an example display of a reader assessment page using the system illustrated in FIGS. 1 and 2;

FIG. 6 illustrates a flow chart of an example method for generating multimedia content through stories using the system illustrated in FIGS. 1 and 2; and

FIG. 7 illustrates a flow chart of an example method for creating multimedia content through stories using the system illustrated in FIGS. 1 and 2.

### DETAILED DESCRIPTION

It is to be understood that the present disclosure may assume various alternative orientations and step sequences, except where expressly specified to the contrary. It is also understood that the specific systems and processes illustrated in the attached drawings, and described in the specification are simply exemplary embodiments of the inventive concepts disclosed and defined herein. Hence, specific dimensions, directions or other physical characteristics relating to the various embodiments disclosed are not to be considered as limiting, unless expressly stated otherwise.

Some portions of the detailed description that follow are presented in terms of algorithms and/or symbolic representations of operations on data bits and/or binary digital signals stored within a computing system, such as within a computer and/or a computing system memory. As referred to herein, an algorithm is generally considered to be a self-consistent sequence of operations and/or similar processing leading to a desired result. The operations and/or processing may take the form of electrical and/or magnetic signals configured to be stored, transferred, combined, compared and/or otherwise manipulated. It has proven convenient at times to refer to these signals as bits, data, values, elements, symbols, characters, terms, numbers, numerals and/or the like. It should be understood, however, that all of these and similar terms are to be associated with appropriate physical quantities and are merely convenient labels. Unless specifically stated otherwise, as apparent from the following discussion, it is appreciated that throughout this specification discussions using terms such as “processing”, “computing”, “calculating”, “determining”, and/or the like refer to the actions and/or processes of a computing device, such as a computer or a similar electronic computing device that manipulates and/or transforms data represented as physical electronic and/or other physical quantities within the computing device's processors, memories, registers, and/or other information storage, transmission, and/or display devices.

Unless specifically stated otherwise, as apparent from the following discussion, it is appreciated that throughout this specification a computing device includes, but is not limited to, a device such as a computer or a similar electronic computing device that manipulates and/or transforms data represented by physical, electronic, and/or magnetic quantities and/or other information storage, transmission, reception, and/or display devices. Accordingly, a computing device refers to a system, a device, and/or a logical construct that includes the ability to process and/or store data in the form of signals. Thus, a computing device, in this context, may comprise hardware, software, firmware, and/or any combination thereof. Where it is described that a user instructs a computing device to perform a certain action, it is understood that “instructs” may mean to direct or cause to perform a task as a result of a selection or action by a user. A user may, for example, instruct a computing device embark upon a course of action via an indication of a selection. A user may include an end-user.

Flowcharts, also referred to as flow diagrams by some, are used in some figures herein to illustrate certain aspects of some examples. Logic they illustrate is not intended to be exhaustive of any, all, or even most possibilities. Their purpose is to help facilitate an understanding of this disclosure with regard to the particular matters disclosed herein. To this end, many well-known techniques and design choices are not repeated herein so as not to obscure the teachings of this disclosure.

Throughout this specification, the term “system” may, depending at least in part upon the particular context, be understood to include any method, process, apparatus, and/or other patentable subject matter that implements the subject matter disclosed herein. The subject matter described herein may be implemented in software, in combination with hardware and/or firmware. For example, the subject matter described herein may be implemented in software executed by a hardware processor.

The aspects and functionalities described herein may operate via a multitude of computing systems, wired and wireless computing systems, mobile computing systems (e.g., mobile phones, tablets, notebooks, and laptop computers), desktop computers, hand-held devices, multiprocessor system, consumer electronics, and the like.

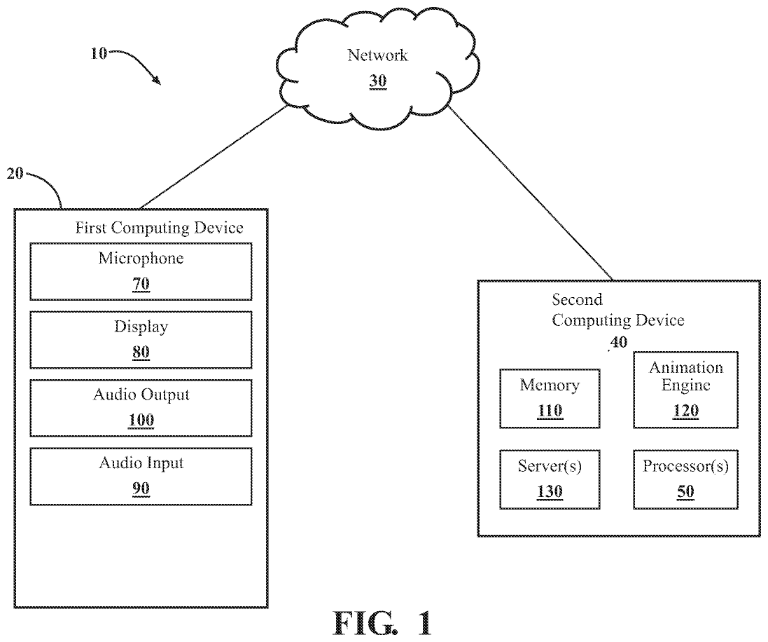

FIG. 1 illustrates an example system 10 for generating and animating multimedia content according to an embodiment of the disclosure. Some multimedia content may be generated based on the accurate pronunciation of words by a user of the system 10. The system 10 comprises a first computing device 20, a network 30, and a second computing device 40. The first computing device 20 may communicate with the second computing device 40 using the network 30, such as wireless “cloud network,” the Internet, an IP network, or the like. In an alternative embodiment, the first computing device 20 may be connected to the second computing device 40 using a hard-wired connection.

The second computing device 40 comprises one or more servers 130, such as web servers, database servers, and application program interface (API) servers. The second computing device 40 may be a desktop computer, a laptop, a tablet, a server computer, or any other functionally equivalent device known in the art. The second computing device 40 also comprise one or more processors/microprocessors 50 capable of performing tasks, such as all or a portion of the methods described herein. The second computing device 40 further comprises memory 110. The memory 110 includes computer-readable instructions that may include computer-readable storage media and computer-readable communication media. The memory 110 may be any type of local, remote, auxiliary, flash, cloud, or other memory known in the art.

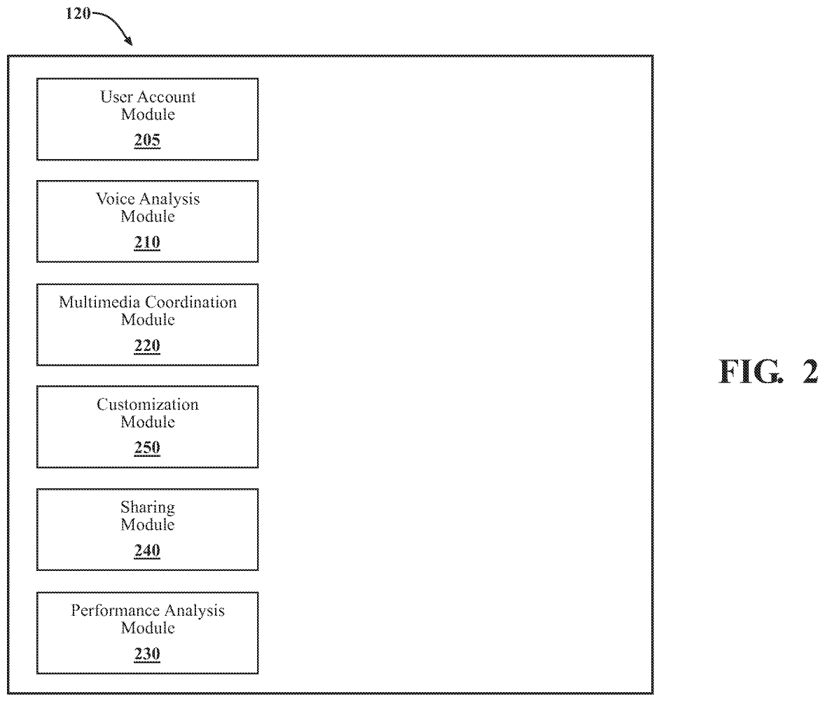

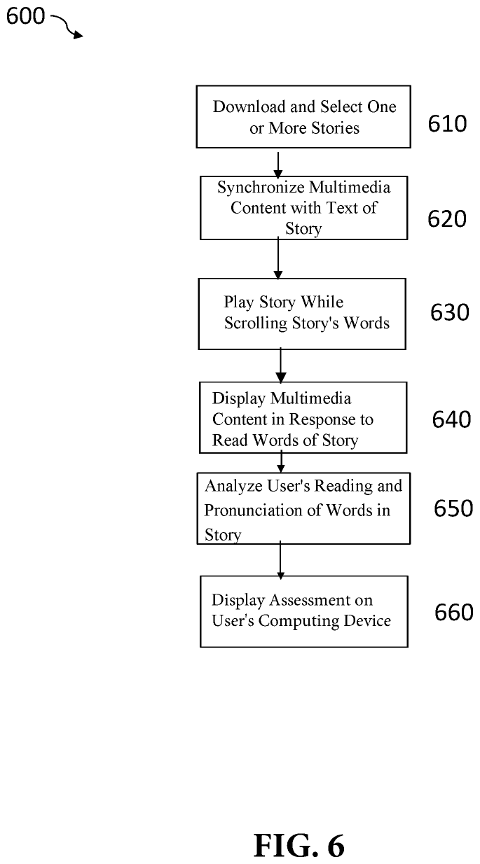

In some embodiments, the memory 110 comprises, but is not limited to, random access memory, read-only memory, flash memory, or any combination of such memories. In some embodiments, the memory 110 includes one or more program modules suitable for running software applications, such as a voice animation engine 120 shown in FIGS. 1 and 2. A number of program modules and data files are stored in the memory 110. The memory 110 provides non-volatile, non-transitory storage for the second computing device 40. While executing on the processors 50, program modules depicted in FIG. 2 perform processes including, but not limited to, one or more of the steps of the method 600 illustrated in FIG. 6, as described below.

The second computing device 40 further comprises one or more databases 60 associated with the one or more servers 130. The databases 60 are configured to store all data related to the system 10, including, but not limited to, stories created and/or accessed via the system 10.

The first computing device 20 may be a laptop, tablet, cellular phone, handheld device, watch, or any other functionally equivalent device capable of running a mobile application. In an embodiment, the first computing device 20 includes a microphone 70, a display 80, an audio input 90, an audio output 100, one or more processors, and memory. The display 80 may be a visual display, such as a screen, that is built-in to the first computing device 20. In some embodiments, the first computing device 20 has one or more input device(s), such as a keyboard, a mouse, a pen, a touch input device, etc.

FIG. 2 shows a schematic block diagram 200 of example modules of the voice animation engine 120 that are created when one of the processors 50 executes instructions stored in the memory 110 of the second computing device 40. The voice animation engine 120 is configured to generate images, videos, text, slide transitions, audio, downloadable content, GIF animation, color backgrounds, page turns, and the like. Examples of the modules include a user account module 205, a voice analysis module 210, a multimedia coordination module 220, a performance analysis module 230, a sharing module 240, a customization module 250, and combinations thereof.

The user account module 205 is configured to build user profiles and authenticate users. The system 10 may be used by a single user, such as a learning user, to create and display multimedia content, such as through stories. The system 10 may also be used collaboratively by a plurality of users, such as a learning user and a teaching user, to create stories, modify stories, and analyze reading patterns, spelling, and pronunciation of the learning users. Teaching users can analyze data and information provided by the system to improve the reading ability of learning users. The teaching user can be, for example, a parent, teacher, mentor, supervisor, and the like. The learning user is a user that is reading or experiencing a story that can be, for example, a child or a student.

The voice analysis module 210 is configured to analyze the words spoken by a user of the system 10. The voice analysis module 210 includes a voice analysis controller configured to receive and detect a user's speech. The voice analysis module 210 includes at least one algorithm for analyzing the words spoken by the user through a listening application program interface (API) on the multimedia coordination module 220. The voice analysis module 210 may also include additional algorithms to help manage and monitor the user's voice patterns and the words that are being read. This enables the reader to move through a story and trigger animation on voice command even if there are errors in their storytelling. Keywords in the script are listened for and matched to the databases 60 to help the user progress and complete the story without having to read every single word correctly.

The multimedia coordination module 220 is configured to synchronize the output from the voice analysis module 210 with multimedia content such as, but not limited to, animations, images, videos, GIFs, websites, sounds, text, and the like. The multimedia content is configured to bring a story to life for the user by matching words spoken by a user with associated words stored in the databases 60. The matching of the spoken words with the stored words in one or more of the databases 60 triggers the creation of visual and/or audio multimedia content that are used to create a story.

In an embodiment, preconfigured stories may be downloaded by a user from one of the databases 60 in the software application. In this embodiment, the stories are created by the system 10.

As a user reads and pronounces words in a presentation/story via the first computing device 20, the spoken words are coordinated with the text in the presentation/story so that the text is visually marked (e.g., highlighted) as the user reads each word. The multimedia coordination module 220 also coordinates multimedia content to match the text as a user is reading the story out loud. Multimedia content is coordinated by accessing the background animations, images, videos, GIFs, websites, sounds, and/or text from the databases 60 and combining the files together into a cohesive multimedia presentation of a story. This creates a fluid animation triggered by a user reading words in the correct sequence and with correct pronunciation.

The multimedia coordination module 220 may be configured to generate one or more pieces of multimedia content upon detection of one or more words or phrases read and/or spoken by a user via the first computing device 20. The multimedia content may include any content designed to be viewed and/or heard by a user.

In an embodiment, the multimedia coordination module 220 stores metadata, such as in the form of rules, that associates the multimedia content with a particular time stamp. As a result, the multimedia content is programmed to generate within a specific period of time after the words in the script of the story are read and/or spoken. Each piece of multimedia content may be programmed to play for specific period of time after being triggered by a word in the story. In other examples, each piece of multimedia content may be configured to play for a random duration of time.

In some embodiments, the multimedia coordination module 220 includes rules that may be applied to any specific word in a script of the story. The rules may generate transitions applied to content, color fades, slides, page turns, and the like when applied to read and/or spoken words.

If the reading of a story is prerecorded in the system 10, it may be accessed from the databases 60 and/or the memory 110 of the second computing device 40. The prerecorded reading may be recorded by a user or may be obtained from a local or online database.

The performance analysis module 230 is configured to monitor, analyze, and report user performance. A user's performance may be based on pronunciation of words in a story, reading speed, reading comprehension, reading level, and reading accuracy of words as detected by the voice analysis module 210. The performance analysis module 230 may generate a numerical score for the user by capturing words in a script that were not correctly read, words that were not read at all, commonly missed or incorrect words, and the overall percentage of words correctly read by a user. This allows the user to monitor their reading progress and earn rewards for correctly reading and pronouncing words. The rewards may include badges, points, coins, and the like. The rewards may be exchanged for other types of prizes using the software application.

The sharing module 240 is configured to communicate information to and from other users. The information may be customized stories, analysis reports about a user's performance, or other files generated in the software application. The information may be communicated from a learning user may be communicated to a teaching user to help improve the learning user's reading and speech development. Specific reading reports may be sent via email to desired recipients.

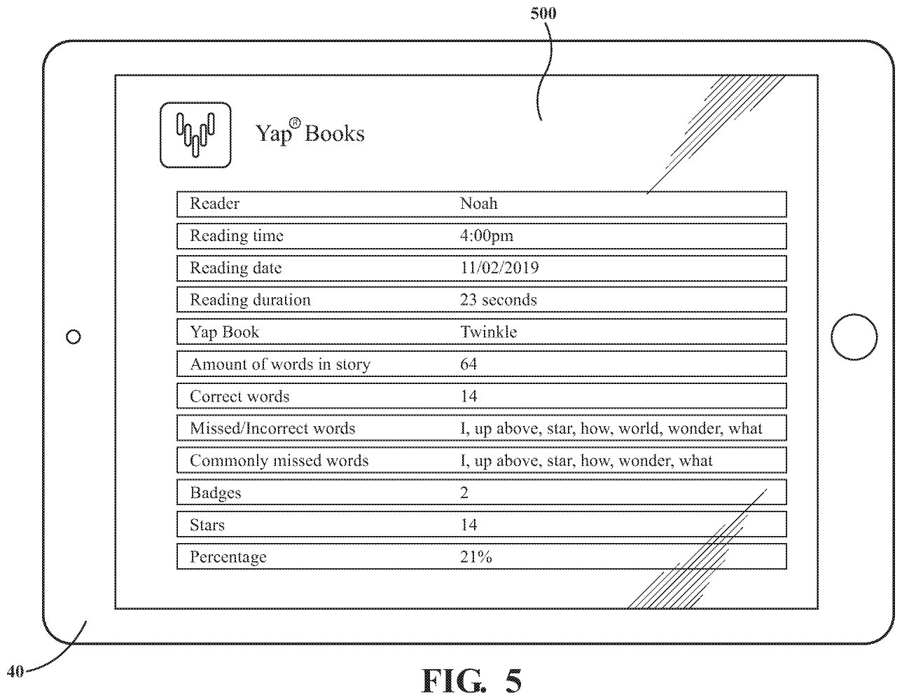

As best seen in FIG. 5, the software application may also provide a user-friendly visualization of each reading score displaying various factors, such as the percentage of words correctly read, reading time, words in a story, missed and commonly missed words, stars and badges earned, reader's name, teacher's name, and name of the selected story.

The customization module 250 is configured to build and customize stories in the system 10 based on feedback received from users. In an embodiment, the customized story may be built by accessing an existing story from one of the databases 60 and editing the story. In an alternative embodiment, the story may be built based solely on input from a user using voice dictation or by typing and applying digital content to the words in a story. The digital content may then be activated by voice when ready by a reader. By selecting each word independently, the user may be able to progressively build upon their story and perform visual adjustments, such as scale, color, rotation, order and position. These visual adjustments would then be revealed to the reader through the reading of a book and the text that has been submitted to the databases 60.

The exemplary modules of the second computing device 40 shown in FIG. 2 may be implemented as one or more software applications. Users interact with the software application via the first computing device 20 by viewing a graphical user interface on the display 80 and by providing input to the second computing device 40 through the microphone 70, the display 80, the audio input 90, the audio output 100, and the input devices.

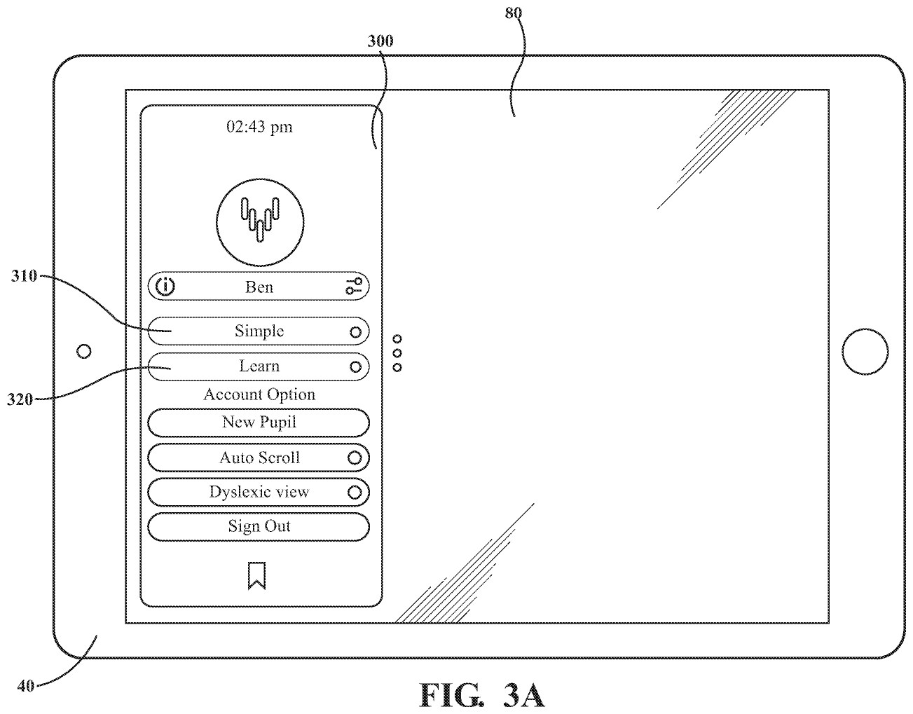

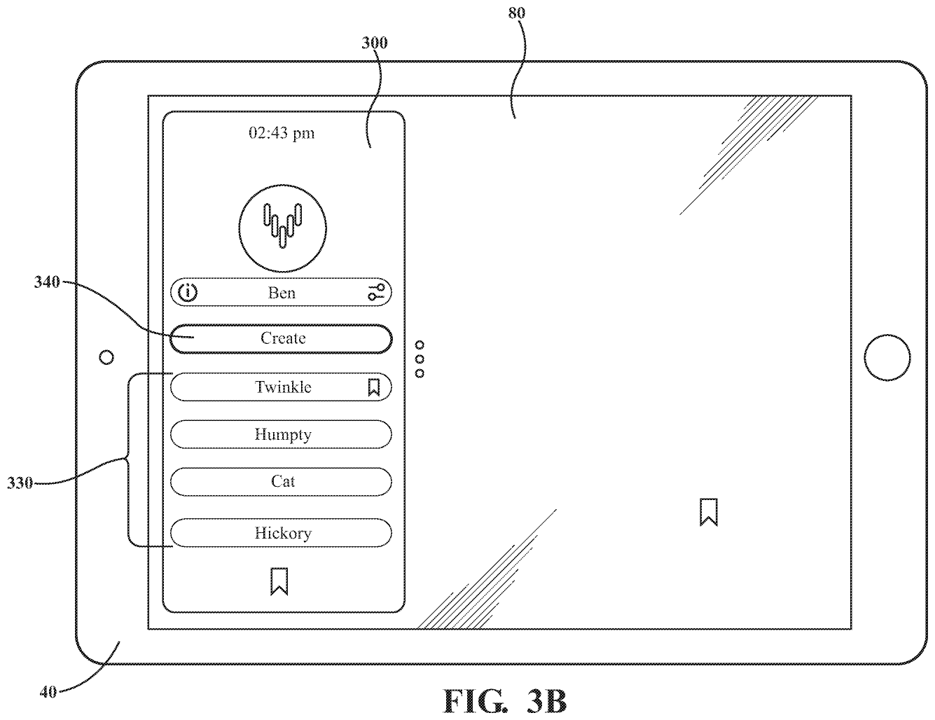

In one example, the software application includes a graphical user interface (GUI) 300, as shown on the display 80 of the first computing device 20 in FIGS. 3A and 3B. The GUI 300 is generated by the system 10. From this page, a user may operate the system 10 through a simple reading mode by selecting the Simple icon 310 or a learning mode by selecting the Learn icon 320. The simple reading mode allows users to move freely through a story even if mistakes or mispronunciations occur.

By using a less stringent set of rules for interpreting vocalized words than the rules used for the learning mode, the simple reading mode offers a more engaging, lighter reader experience. In an example, the 2 & 1 word simplification allows users to not have to be restricted by pronouncing full words. Instead, users can pronounce at least two letters in one word followed by one letter in the next word so that users can still move through a story and be entertained. In another example, users move forward by pairing two word sequences in a script of a story. In yet another example, the system 10 accounts for a full stop/gap between words by matching the last word before the full stop and then initiating a restart into a new sentence. This helps limit any inaccuracies with the reading algorithm with the voice animation engine 120.

From the home page of the software application, a user can also select a story from a list of stories 330 that have already been downloaded to the user's account, as seen in FIG. 3B. Each story may be preconfigured to generate certain multimedia content at certain times based upon the vocalization of certain words in the story as a user reads the story. In addition to, or instead of, selecting from one of the downloaded stories, the user may create their own story by selecting the Create icon 340.

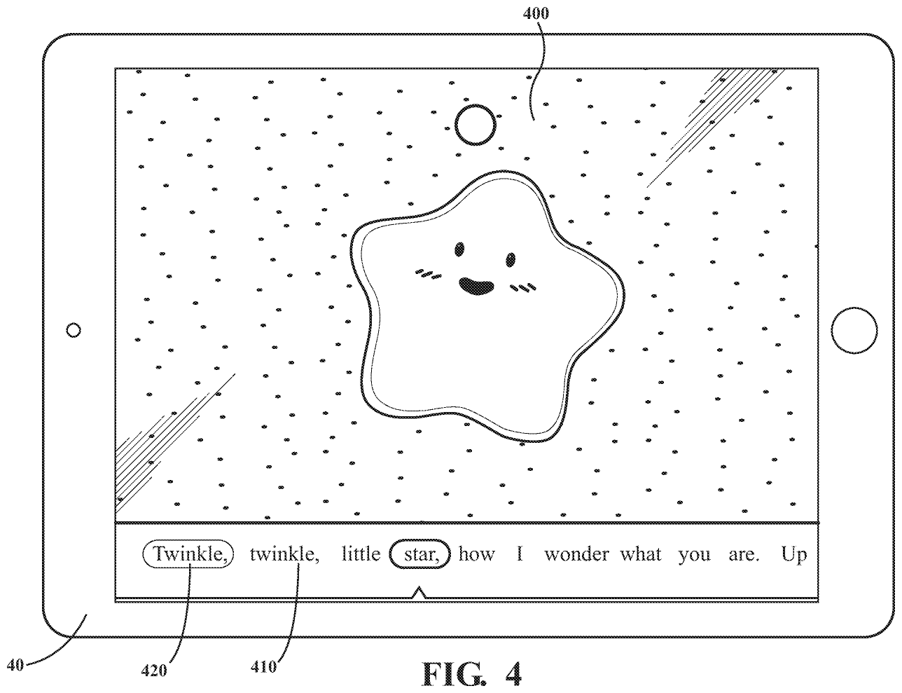

FIG. 4 shows a graphical user interface (GUI) 400, as shown on the display 80 of the first computing device 20, of an example story page selected from the home page. After the story is played, it can be stopped and started at any spot and at any time by the user. The story page includes a reading bar 410 that displays the words to the story. A user may scroll left and right along the reading bar 410 to see the words in the story. The story page also includes a progression bar 420 that displays a user's progress by highlighting/marking the words of a story that have already been read.

As the user progresses through the words of a story, new multimedia content appears in association with the words that are ready in order to animate the story. At the same time, the reading bar 410 continues moving forward to display the next words in the story for the user to read.

The story page also includes an assessment icon that directs the user to a graphical user interface 500 of a user assessment page, as shown in FIG. 5. The user assessment page provides an analysis report of the user's reading of the story. The user reading assessment page may display various information, such as the date/time of the reading, the reading duration, the name of the story/book, the amount of words in a story, the number of words correctly read/pronounced, the types of missed or incorrect words, and the number of rewards earned by the user.

FIG. 6 illustrates a flow chart of an example method 600 for generating multimedia content through stories using the system 10. The method begins at block 610 where one or more preconfigured stories/books are downloaded to a user's account from the one or more of the databases 60. The user can then select a specific story/book using the display 80 on the first computing device 20. The system 10 categorizes the stories by age ranges and reading levels.

After the user selects a story/book, the voice animation engine 120 synchronizes with the multimedia content that is specifically associated with the selected story/book, as shown in block 620. This is done by the second computing device 40. The story is then played on the display 80 and the user begins to read out load, via the audio output 100 of the first computing device 20, the words of the story that are displayed on the reading bar 410, as shown in block 630.

As the user is reading/vocalizing the words of the story via the first computing device 20, multimedia content, such as animation, begins to appear on the display 80. The multimedia content appears in response to the system's 10 determination that the user has successfully pronounced words in the story, as shown in block 640. The animated story is played through the display 80 and the audio output 100 of the first computing device 20. The reading bar 410 continues scrolling and visually marking (e.g. highlighting) specific words in the story as the user continues reading through the story.

Next, as shown in block 650, the user's reading and pronunciation of words in the story are analyzed by the voice animation engine 120 to generate a reading assessment for the user. Depending on the results of the analysis by the voice animation engine 120, the user may be rewarded based on the user's reading and pronunciation performance.

In block 660, the assessment generated by the by the voice animation engine 120 is then displayed and reported on the display 80 of the first computing device 20 for the user. The assessment may be readily shared with third-parties.

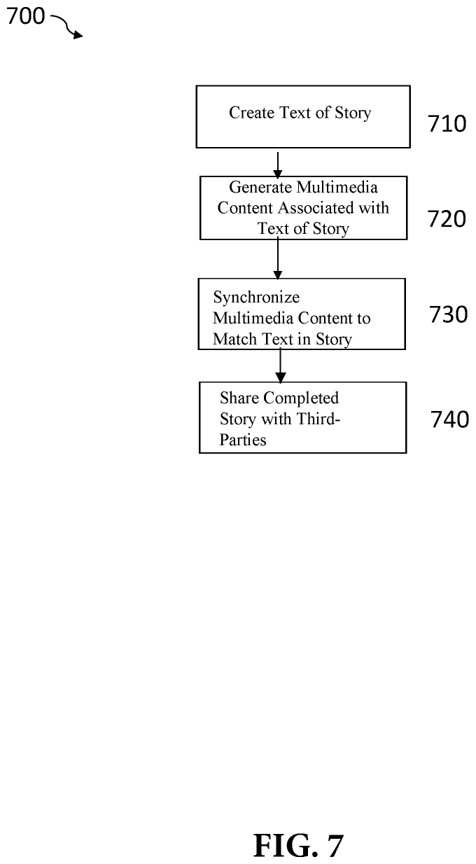

FIG. 7 illustrates a flow chart of an example method 700 for creating multimedia content through stories using the system 10 illustrated in FIGS. 1 and 2. In block 710, the voice animation engine 120 allows a user to create the text portion of a story. This occurs when the user, via the first computing device 20, provides input for the story to the second computing device 40. The input may determine one or more of a title, an audience, a language, a setting, a plot, and one or more characters for the story.

Next, as shown in block 720, the user identifies the type and includes the type of multimedia content to be associated with the words of the story. For example, the text portion may state “Say hello to the busy bumblebee” and the word “bumblebee” may be specifically associated with an animation of a bumblebee.

The system 10 then associates/synchronizes, via the voice animation engine 120, the created multimedia content to match the text of the story, as shown in block 730. This ensures that the multimedia content is generated in response to correctly read/pronounced text in the story.

Once the story is completed, the story is shared by the user with third parties, as shown in block 740. The story may be shared in a variety of ways, including playing the story during an interactive meeting. As a result, the story may allow teachers to collaborate with students through a virtual classroom where third-party students may learn to read through the story.

The system 10 is configured to allow users to create and sell stories/books to other users. In addition to creating and providing their own created stories/books for sale, users may purchase stories that were created by other users. These stories may be stored and downloaded from one of the databases 60 of the system 10.

The software application disclosed herein may also be utilized with augmented reality (AR) or virtual reality (VR devices).

It is to be understood that the various embodiments described in this specification and as illustrated in the attached drawings are simply exemplary embodiments illustrating the inventive concepts as defined in the claims. As a result, it is to be understood that the various embodiments described and illustrated may be combined from the inventive concepts defined in the appended claims.

In accordance with the provisions of the patent statutes, the present disclosure has been described to represent what is considered to represent the preferred embodiments. However, it should be noted that this disclosure can be practiced in other ways than those specifically illustrated and described without departing from the spirit or scope of this disclosure.

What is claimed is:

1. A computer-implemented method for animating multimedia content, the method comprising:
creating a customized story based on input from a user, the input determining one or more words and one or more types of multimedia content for the story;
synchronizing the one or more types of multimedia content to match the one or more words of the story;
displaying the words of the story to a user via a computing device;
determining whether the words of the story were correctly vocalized in the correct order by the user;
playing the multimedia content through a display and an audio output on the computing device in response to one or more correctly vocalized words in the story by the user;
analyzing the user's reading and pronunciation of the words in the story; and
displaying on the computing device the assessment of the user's reading and pronunciation of the words in the story.

2. The computer-implemented method of claim 1, further comprising rewarding the user based on the user's reading and pronunciation performance.

3. The computer-implemented method of claim 1, wherein the multimedia content comprises one or more images, videos, text, slide transitions, audio, downloadable content, GIF animation, color backgrounds, page turns, and any combinations thereof.

4. The computer-implemented method of 1, wherein the analysis of the user's reading and pronunciation of the words in the story comprises one or more of the percentage of words correctly read in the story, reading time of the story, words in a story, missed and commonly missed words in the story.

5. The computer-implemented method of claim 1, wherein determining whether the words of the story were correctly vocalized in the correct order by the user comprises matching the vocalized words with stored audio recordings the these words.

6. The computer-implemented method of claim 1, further comprising pausing and re-starting the story based on selections by the user on the computing device.

7. The computer-implemented method of claim 1, further comprising visually marking words in the story as the user is reading the story on the computing device.

8. The computer-implemented method of claim 1, wherein the input from the user determines one or more of the scale, color, rotation, order and position of the words and the types of multimedia content in the story.

9. A computer-implemented method for animating multimedia content, the method comprising:
displaying a list of pre-configured stories to a user via a computing device;
synchronizing one or more types of multimedia content to match one or more words of a story selected by the user;
displaying the words of the story on the computing device for the user to vocalize;
determining whether the words of the story were correctly vocalized in the correct order by the user;
playing the multimedia content through a display and an audio output on the computing device in response to one or more correctly vocalized words in the story by the user;
analyzing the user's reading and pronunciation of the words in the story; and
displaying on the computing device the analysis of the user's reading and pronunciation of the words in the story.

10. The computer-implemented method of claim 9, further comprising rewarding the user based on the user's reading and pronunciation performance.

11. The computer-implemented method of claim 9, wherein the multimedia content comprises one or more images, videos, text, slide transitions, audio, downloadable content, GIF animation, color backgrounds, page turns, and any combinations thereof.

12. A system for animating multimedia content, the system comprising:
a first computing device comprising:
a microphone;
a display;
an audio input; and
an audio output; and
a second computing device in communication with the first computing device, wherein the second computing device comprises:
one or more databases;
one or more servers in communication with the one or more databases;
one or more processors; and
a computer-readable memory encoding instructions that, when executed by the one or more processors, create a voice animation engine configured to generate one or more types of multimedia content, wherein the voice animation engine comprises:
a customization module programmed to create a story based on input received from the first computing device;
a voice analysis module programmed to analyze words in the story spoken by a user via the first computing device, wherein the voice analysis module includes a voice analysis controller;
a multimedia coordination module programmed to synchronize the output from the voice analysis module with one or more types of multimedia content; and
a performance analysis module programmed to analyze and report the user's reading and pronunciation of the words in the story.

13. The system of claim 12, further comprising an account module programmed to build user profiles and authenticate users.

14. The system of claim 12, further comprising a sharing module programmed to communicate information to and from other users.

15. The system of claim 12, wherein the multimedia content comprises one or more images, videos, text, slide transitions, audio, downloadable content, GIF animation, color backgrounds, page turns, and any combinations thereof.
